(19) United States
(12) Patent Application Publication
(10) Pub. No.: US 2019/0324406 A1
(43) Pub. Date: Oct. 24, 2019

(54) ELECTRONIC TIMEPIECE

(71) Applicant: Seiko Epson Corporation, Tokyo (JP)

(72) Inventor: Chisato TEZUKA, Okaya (JP)

(21) Appl. No.: 16/390,059

(22) Filed: Apr. 22, 2019

(30) Foreign Application Priority Data
Apr. 23, 2018 (JP) 2018-082327

(51) Int. Cl. G04C 3/14; G04C 9/08; G04R 60/14

(52) U.S. Cl. CPC G04C 3/146; G04R 60/14; G04C 9/08

(57) ABSTRACT

An electronic timepiece that drives a function indicator and a calendar wheel with a single motor, and can return the function indicator to the reference position when the position of the function indicator shifts due to an external disturbance. The electronic timepiece has a function indicator for displaying information other than time; a driver that drives the function indicator; a display member that is driven in conjunction with the function indicator to display information based on time; an indicator position detector configured to detect the function indicator at an indicator position detection position; and a controller that controls the driver and the indicator position detector to execute a function indicator position detection process.

### BACKGROUND

### 1. Technical Field

The present invention relates to an electronic timepiece.

### 2. Related Art

Timepieces that drive multiple hands with a single motor in order to provide a timepiece with many functions in a compact space are known from the literature. See, for example, JP-A-2016-191603. The timepiece described in JP-A-2016-191603 is configured to drive a function indicator (mode indicator) and a day indicator (date indicator) with a single stepper motor, and uses a Geneva drive to change the position indicated by the date indicator one day each time the function indicator turns five revolutions.

In an electronic timepiece that drives the hands with a motor, when the position of the function indicator is changed due to the effects of an external disturbance such as a strong magnetic field or the timepiece being dropped, for example, the relationship between the position of the function indicator and the date indicator also changes, and after the date indicator is moved, the function indicator cannot be returned to the normal reference position.

### SUMMARY

An object of this invention is to provide an electronic timepiece that uses a single motor to drive a function indicator and a display member, such as a date indicator, that displays information based on time, and can return the function indicator to the reference position when the position of the function indicator is changed by an external disturbance.

An electronic timepiece according to the invention has a function indicator for displaying information other than time; a driver that drives the function indicator; a display member that is driven in conjunction with the function indicator to display information based on time; an indicator position detector configured to detect the function indicator at an indicator position detection position; and a controller that controls the driver and the indicator position detector to execute a function indicator position detection process.

When the position of the function indicator shifts due to an external disturbance, the position of the function indicator can be detected by the indicator position detection mechanism in this configuration. The function indicator can therefore be reset to the reference position based on the detected position of the function indicator even when the position of the function indicator is affected by an external disturbance, and correct information can be indicated by the function indicator. Furthermore, because the relative positions of the function indicator and a display member that displays time-based information, such as a date indicator, can be correctly determined, the controller can also move the display member correctly.

An electronic timepiece according to another aspect of the invention preferably executes the indicator position detection process immediately after a system reset.

In the initial state after a system reset of the electronic timepiece, the position of the function indicator is unknown and correct information can therefore not be reliably indicated. However, because the controller in this aspect of the invention automatically executes the indicator position detection process immediately following a system reset, the position of the function indicator can be detected. As a result, the function indicator can be moved to the correct normal position, and the correct relationship to a display member that is driven in conjunction with the function indicator can be maintained.

In an electronic timepiece according to another aspect of the invention, the controller executes the indicator position detection process in response to input instructing setting the function indicator to the reference position.

In this configuration, the controller can run the indicator position detection process when the user uses a button or other operating member of the electronic timepiece to instruct resetting the function indicator to the reference position. As a result, when the user notices that the position of the function indicator has shifted due to the effects of magnetism or other external factor, the user can cause the controller to run the indicator position detection process to move the function indicator to the normal position so that the normal relationship to the display member is maintained.

In an electronic timepiece according to another aspect of the invention, the controller preferably executes the indicator position detection process regularly.

In this aspect of the invention the controller executes the indicator position detection process on a regular schedule, and the position indicated by the function indicator can be automatically adjusted. As a result, even when the user does not notice that the position of the function indicator has shifted due to the effects of magnetism or other external factor, the function indicator can be moved to the normal position so that the normal relationship to the display member is maintained. The function indicator can therefore always indicate correct information.

In an electronic timepiece according to another aspect of the invention, the display member is preferably a calendar wheel, and the controller executes the indicator position detection process when controlling driving the calendar wheel.

To drive the function indicator and calendar wheel in conjunction with each other by a common driver, the driver can be configured with a Geneva drive so that the calendar wheel is driven when the function indicator turns multiple revolutions (such as six revolutions). Because the position of the function indicator is detected at a single location during the six revolutions of the function indicator, the function indicator makes a maximum six revolutions when detecting the position of the indicator. If the indicator position is detected when the date changes (when driving the date indicator), the indicator position can be detected at the same time the function indicator is normally driven to move the calendar wheel.

More specifically, if the indicator position detection process executes at a time other than when the date changes, the function indicator may make multiple revolutions during the middle of the day when the user is wearing the timepiece, and user convenience is decreased. The indicator position detection process and the date driving process must also separately drive the function indicator, and per-day power consumption increases.

However, if the indicator position detection process executes when the date changes, the function indicator is driven multiple rotations in the middle of the night when the user is typically not wearing the timepiece, and a loss of user convenience can be prevented. The function indicator is also driven multiple revolutions only once a day, and per-day power consumption can be reduced.

Further preferably in an electronic timepiece according to another aspect of the invention, the reference position of the function indicator and the indicator position detection process are different positions; and the controller stores a movement control distance the function indicator is moved from the indicator position detection position to the reference position.

This configuration sets the reference position of the function indicator to a different position than the indicator position detection position, and the controller stores the movement control distance, that is, the amount the function indicator must move between the two positions. The location of the reference position relative to the indicator position detection position can therefore be set freely by simply changing the setting of this movement control distance. More specifically, the indicator position detection position may be set to a location easily accommodating the indicator position detection mechanism, or a location enabling easily installing the wheels of the wheel train that drives a display member. The reference position of the function indicator can also be freely set to a position where the display member does not move when the function indicator moves within a specific range.

A layout enabling easy assembly in a confined space can therefore be achieved, the reference position of the function indicator can be set to a position appropriate to the design of the timepiece and the information to be displayed, and a small, highly utilitarian electronic timepiece can be provided.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows the face of an electronic timepiece according to a preferred embodiment of the invention.

FIG. 2 is a section view through line II-II in FIG. 1.

FIG. 3 is a plan view of the face side of the movement of the electronic timepiece shown in FIG. 1.

FIG. 4 is a plan view of the back side of the movement of the electronic timepiece shown in FIG. 1.

FIG. 5 is an exploded oblique view of main parts of the movement of the electronic timepiece shown in FIG. 1.

FIG. 6 is a plan view of the wheel train for driving the mode indicator, and the wheel train of the indicator position detection mechanism, of the electronic timepiece shown in FIG. 1.

FIG. 7 is a plan view of the date indicator wheel train and date jumper of the electronic timepiece shown in FIG. 1.

FIG. 8 is a block diagram showing the relationship between the controller, motor, wheel trains, and indicator position detectors of the electronic timepiece shown in FIG. 1.

FIG. 9 illustrates the relationship between mode indicator position, mode step count, indicator display range, date jumper, and date changing range.

FIG. 10 is a flow chart of the mode indicator position detection process when changing the date.

FIG. 11 is a flow chart of the mode indicator position detection process during a system reset.

### DESCRIPTION OF EMBODIMENTS

Electronic Timepiece

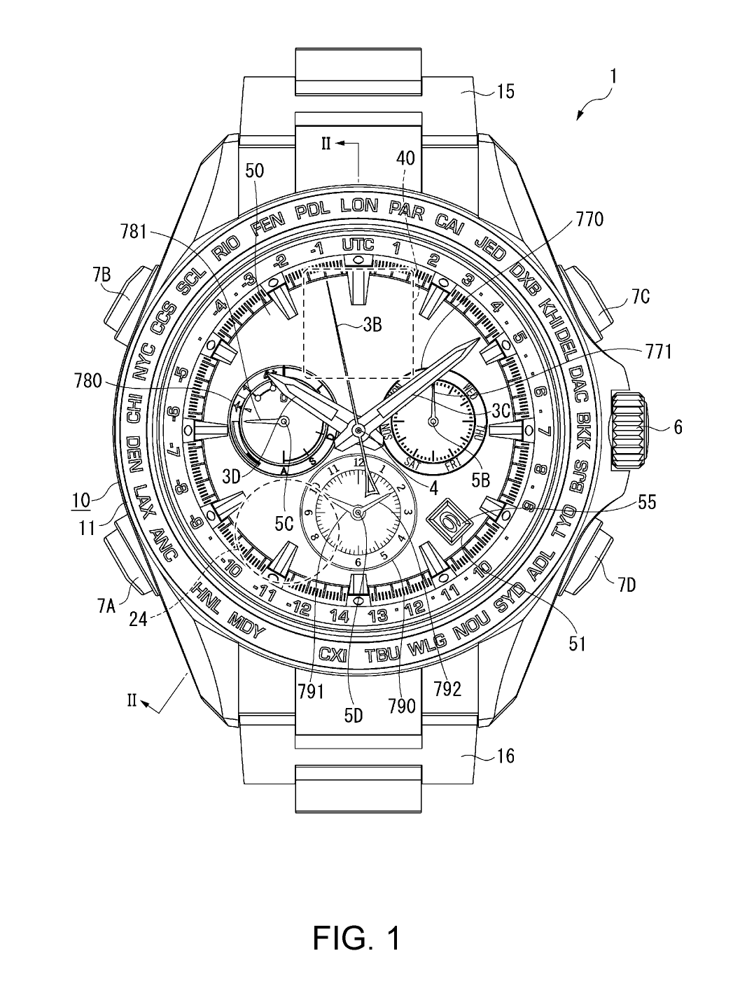

As shown in FIG. 1, an electronic timepiece 1 according to this embodiment of the invention is a multifunction timepiece with three small windows (subdials) 770, 780, 790. The configuration of this electronic timepiece 1 is described below with reference to FIG. 1 to FIG. 3.

Note that herein the views of the electronic timepiece 1 perpendicularly to the dial from the crystal side and the back cover side are referred to as plan views.

The electronic timepiece 1 according to this embodiment is configured to receive satellite signals from positioning information satellites such as GPS satellites and quasi-zenith satellites that orbit the Earth on specific known orbits, acquire satellite time information, and adjust internal time information. The satellite signal reception process of the electronic timepiece 1 includes a manual reception mode that is started by the user operating a button, for example, and an automatic reception mode that starts automatically when specific conditions are met.

As shown in FIG. 1 to FIG. 3, the electronic timepiece 1 has an external case 10 that houses a dial 50, movement 20, planar antenna 40, and storage battery 24. The electronic timepiece 1 also has external operators such as a crown 6 and four buttons 7A, 7B, 7C, 7D, and a band connected to the external case 10.

The band includes a first band 15 that connects to the external case 10 at the 12:00 side, a second band 16 that connects to external case 10 at the 6:00 side, and a clasp not shown. The first band 15 and second band 16 are metal bands each including an end piece made of titanium or other metal that attaches to the external case 10, and multiple metal links. Note that the band is not limited to a metal band, and may be a leather band or a plastic band, for example.

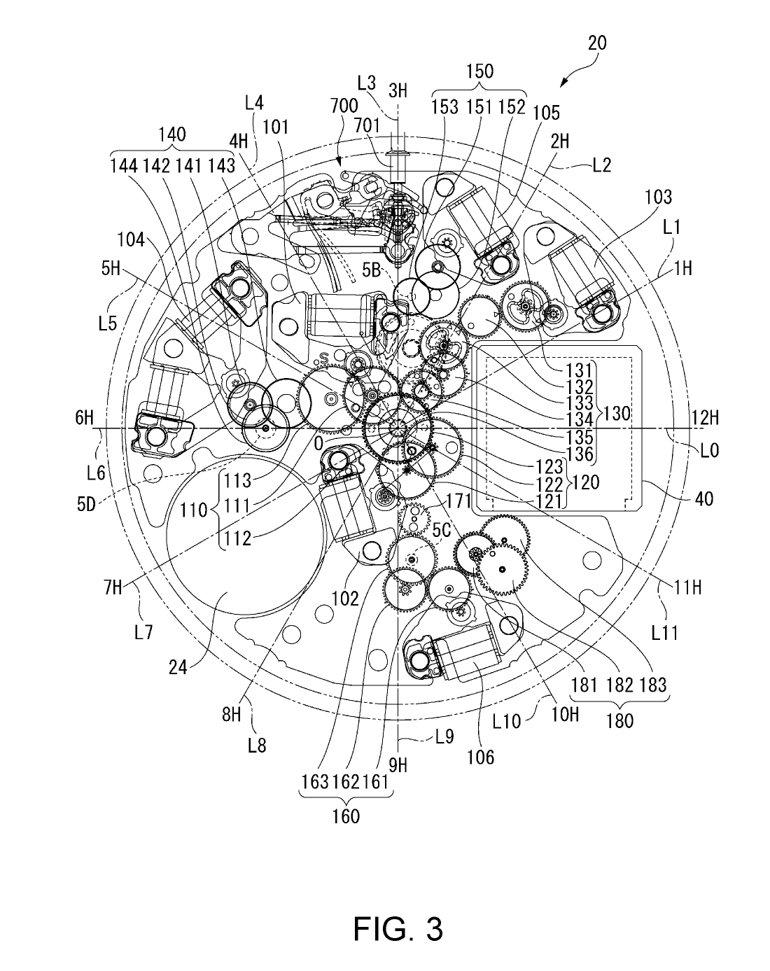

The dial 50 is a round disk made of polycarbonate or other electrically non-conductive material. In the plane center O of the dial 50 (FIG. 3) is disposed a center arbor 4 (including a second hand pivot 4B, minute hand pivot 4C, and hour hand pivot 4D) passing through the dial 50, and hands 3 (second hand 3B, minute hand 3C, hour hand 3D) are attached to the center arbor 4.

The dial 50 has three windows (subdials). As shown in FIG. 1, relative to the plane center O of the dial 50 where the center arbor 4 is disposed, a round first subdial 770 and a small hand 771 are disposed at 3:00, a round second subdial 780 and small hand 781 are disposed at 9:00, and a round third subdial 790 and small hands 791 and 792 are disposed at 6:00.

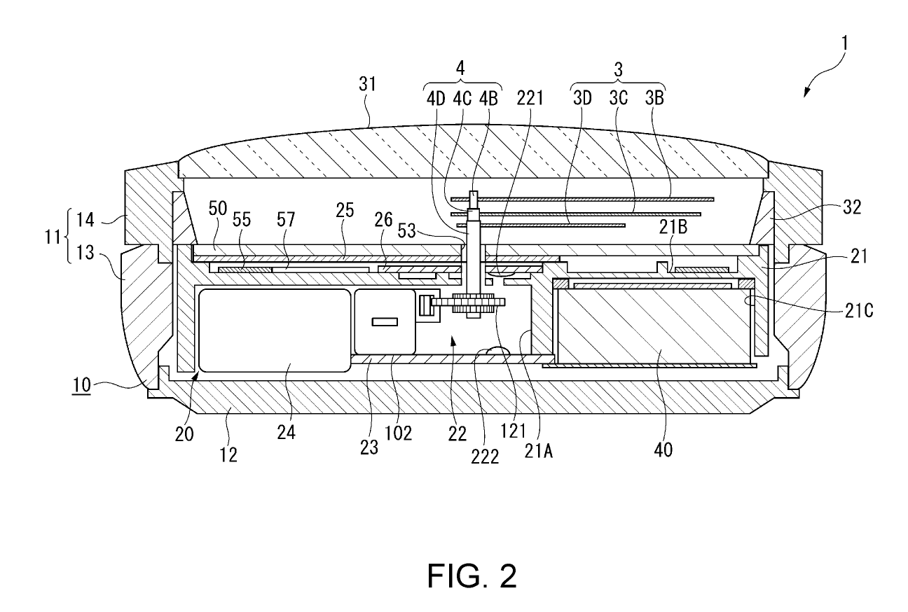

A rectangular date window 51 is disposed relative to the plane center O of the dial 50 in the direction between 4:00 and 5:00 (at the 4:30 position). As shown in FIG. 2, a date indicator 55 is disposed on the back cover side of the dial 50, and the date indicator 55 can be seen through the date window 51. The dial 50 also has a through-hole 53 through which the through-hole 53 passes, and through-holes (not shown in the figure) through which the pivots 5B, 5C, 5D of the hands 771, 781, 791, 792 pass.

In this embodiment, the small hand 771 of the first subdial 770 is a day hand indicating the day of the week, and the small hand 781 of the second subdial 780 is a mode indicator (function indicator) for indicating other information. The hands 791, 792 of the third subdial 790 are the hour hand and minute hand for indicating the time, such as the home time or local time, in a second time zone.

The second hand 3B, minute hand 3C, hour hand 3D, hands 771, 781, 791, 792, and date indicator 55 are driven by a motor and wheel train described below.

The second subdial 780 has markers pointed to by a mode indicator, small hand 781 in this example, including a power indicator for indicating the power reserve of the storage battery 24, a daylight saving time mode setting, internal mode setting, and a GPS satellite signal reception mode setting.

The power indicator is a band extending from 9:00 to 7:00 on the second subdial 780, the 9:00 position indicating a full charge (F), and the 7:00 position indicating an empty charge (E).

More specifically, when the battery voltage of the storage battery 24 is greater than or equal to a first threshold, the small hand 781 points to F indicating there is a sufficient charge, and when the battery voltage is below a second threshold, which is lower than the first threshold, the small hand 781 points to E indicating an insufficient charge.

When the battery voltage is greater than or equal to second threshold and less than the first threshold voltage, the small hand 781 points to a position between F and E (such as 8:00), indicating that the charge is decreasing.

The F (9:00) position is the reference position of the small hand 781 as described below.

The markers for indicating the daylight saving time mode setting include an A at 6:00, an S at approximately 5:00, and a D at approximately 4:00.

The ‘A’ means an AUTO mode for automatically setting daylight saving time. The AUTO mode is a mode for automatically changing the daylight saving time setting using data stored in storage of the electronic timepiece 1 when positioning information is acquired from satellite signals. As a result, a database relationally storing location information, time zone information related to the location information, and daylight saving time setting data appropriate to the location information, is stored in the storage of the electronic timepiece 1.

The ‘S’ indicates a STD mode (standard mode) for always displaying the standard time in response to a manual setting.

The ‘D’ means the daylight saving time (DST) mode, and indicates a mode for always displaying daylight saving time in response to a manual setting.

An airplane icon indicating the airplane mode is displayed at the 10:00 of the second subdial 780, a ‘1’ marker indicating the timekeeping mode of the reception mode is shown at approximately 11:00, and a ‘ 4+’ marker indicating the navigation mode of the reception mode is shown at approximately 12:00. An ‘L’ marker indicating a reception mode for acquiring leap second information is shown at approximately 1:00.

External Structure of the Electronic Timepiece

As shown in FIG. 1 to FIG. 3, the electronic timepiece 1 has an external case 10 housing the movement 20 and other components described below. Note that FIG. 2 is a section view through line II-II in FIG. 1 through the 7:00 position of the dial 50, the plane center O of the dial 50, and 12:00. FIG. 3 is a plan view of the main parts of the movement 20 from the back cover side.

As shown in FIG. 2, the external case 10 has a case member 11, back cover 12, and crystal 31. The case member 11 includes a cylindrical body 13, and a bezel 14 disposed on the face side of the body 13.

A round back cover 12 that closes the opening on the back cover side of the case member 11 is disposed on the back cover side of the case member 11. The back cover 12 connects to the body 13 of the case member 11 by a screw thread configuration. Note that in this embodiment the body 13 and back cover 12 are separate parts, but the invention is not so limited and the body 13 and back cover 12 may be integrated as a one-piece case.

The body 13, bezel 14, and back cover 12 in this embodiment are made from a metal such as stainless steel, a titanium alloy, aluminum, or brass.

Internal Configuration of the Electronic Timepiece

The internal configuration housed inside the external case 10 of the electronic timepiece 1 is described next.

In addition to the dial 50, a movement 20, planar antenna 40 (patch antenna), date indicator 55, and dial ring 32 are housed inside the external case 10 as shown in FIG. 2.

Note that, in the description of the movement 20 below, the back cover side of the main plate 21 is referred to as the front side, and the dial side of the main plate 21 is referred to as the back side.

The movement 20 includes a main plate 21, wheel train bridge (not shown in the figure), drive module 22 supported by the main plate 21 and wheel train bridge, circuit board 23, storage battery 24, solar cell panel 25, and light sensor circuit board 26.

The main plate 21 is made of plastic or other electrically non-conductive material. The main plate 21 has a drive module holder 21A for holding the drive module 22; a date indicator holder 21B where the date indicator 55 is disposed; and an antenna holder 21C where the planar antenna 40 is housed. The date indicator holder 21B is configured as a ring-shaped channel formed on the back side of the main plate 21.

The drive module holder 21A and antenna holder 21C are disposed on the front side of the main plate 21. Because the antenna holder 21C is at the 12:00 position of the dial 50 in plan view, the planar antenna 40 is at the 12:00 position as shown in FIG. 1 and FIG. 3. More specifically, the planar antenna 40 is located between the center arbor 4 of the hands 3 and the case member 11, and between the approximately 11:00 and approximately 1:00 positions on the dial 50. Therefore, as shown in FIG. 3, on an imaginary 12:00 line L0 from the plane center O of the dial 50 toward 12:00, at least part of the planar antenna 40 is superimposed on the imaginary 12:00 line L0 in plan view. More specifically, the plane center of the planar antenna 40 is superimposed in plan view with the imaginary 12:00 line L0. Note that the plan view in reference to FIG. 3 means looking at the front side (the back cover 12 side) of the movement 20.

Note that the line connecting the center arbor 4 (plane center O of the dial 50) and the 12:00 position on the dial 50 is referred to below as the imaginary 12:00 line L0 described above; the lines connecting the arbor (plane center O) to the 1:00 to 11:00 positions are referred to as the 1:00 imaginary line L1, 2:00 imaginary line L2, 3:00 imaginary line L3, 4:00 imaginary line L4, 5:00 imaginary line L5, 6:00 imaginary line L6, 7:00 imaginary line L7, 8:00 imaginary line L8, 9:00 imaginary line L9, 10:00 imaginary line L10, and 11:00 imaginary line L11.

The storage battery 24 is disposed in an area including 6:00 on the dial 50 when the area superimposed on the dial 50 in plan view is divided into two areas by the 3:00 imaginary line L3 and the 9:00 imaginary line L9. More specifically, in plan view, the storage battery 24 is disposed to a position between the 6:00 imaginary line L6 and the 8:00 imaginary line L8, that is, superimposed on the 7:00 imaginary line L7.

The drive module 22 is housed in the drive module holder 21A of the main plate 21, and drives the second hand 3B, minute hand 3C, hour hand 3D, hands 771, 781, 791, 792 date indicator 55.

As shown in FIG. 3, the drive module 22 includes a first motor 101 and first wheel train 110 for driving the second hand 3B; a second motor 102 and second wheel train 120 for driving the minute hand 3C; and a third motor 103 and third wheel train 130 for driving the hour hand 3D.

The drive module 22 also has a fourth motor 104 and fourth wheel train 140 for driving small hands 791, 792; a fifth motor 105 and fifth wheel train 150 for driving small hand 771; and a sixth motor 106 and sixth wheel train 160 for driving small hand 781. The sixth motor 106 and sixth wheel train 160 thus configure a drive mechanism for driving the small hand 781, which in this example is a function indicator.

The date indicator 55 may be driven by adding another dedicated motor, but in this embodiment of the invention is configured to move the date indicator 55 one day when the small hand 781 turns a specific number of revolutions (such as six revolutions) by adding a date indicator wheel train 170 including a Geneva drive to the sixth motor 106 and sixth wheel train 160 that drive the small hand 781. A indicator position detection wheel train 180 that moves in conjunction with the sixth wheel train 160 is also provided for detecting the position of the small hand 781.

The motors 101 to 106 are stepper motors for keeping time, and only the fourth motor 104 is a two-coil stepper motor having two coils.

The motors 101 to 106 and an IC chip embodying a controller 60 are mounted on the circuit board 23, which is disposed to the back cover side of the main plate 21 and affixed to the main plate 21 by screws in this example.

A solar cell panel 25 is disposed to the back side of the dial 50, and converts light received through the dial 50 to electrical energy. Note that to assure sufficient output voltage without using a boost converter, the solar cell panel 25 is divided into multiple cells (such as six to eight), and the cells are connected in series. The power generated by the solar cell panel 25 charges the storage battery 24 through the circuit board 23.

The light sensor circuit board 26 is disposed between the solar cell panel 25 and the main plate 21. The light-emitting devices 211, 221, 231, 241 of the indicator position detectors 210, 220, 230, 240 are disposed to the light sensor circuit board 26.

Motor Locations

In plan view, the first motor 101 is disposed to a position superimposed on the 4:00 imaginary line L4, and between the winding stem 701 of the setting mechanism 700 and the center arbor 4 (plane center O).

In plan view, the second motor 102 is disposed to a position superimposed on the 8:00 imaginary line L8, and between the storage battery 24 and planar antenna 40.

In plan view, the third motor 103 is disposed to a position between the winding stem 701 of the setting mechanism 700 and the planar antenna 40, and more specifically between the 2:00 imaginary line L2 and planar antenna 40. Part of the third motor 103 is superimposed on the 1:00 imaginary line L1.

In plan view, the fourth motor 104 is disposed to a position between the storage battery 24 and winding stem 701 of the setting mechanism 700, and superimposed on the 5:00 imaginary line L5 and the 6:00 imaginary line L6.

In plan view, the fifth motor 105 is disposed to a position superimposed on the 2:00 imaginary line L2, and between the winding stem 701 of the setting mechanism 700 and the third motor 103.

In plan view, the sixth motor 106 is disposed to a position with part superimposed on the 10:00 imaginary line L10, and the rotor and coil of the sixth motor 106 between the 9:00 imaginary line L9 and the 10:00 imaginary line L10.

As a result, the motors 101 to 106 are disposed to positions in plan view not superimposed with the planar antenna 40, storage battery 24, or winding stem 701.

The pivot 5B to which the small hand 771 is attached, the pivot 5C to which the small hand 781 is attached, and the pivot 5D to which the hands 791, 792 are attached are all disposed within the inside circumference of the date indicator 55.

The first wheel train 110 includes an intermediate second wheel 111 that meshes with the rotor pinion of the first motor 101, a second wheel 112 that meshes with the pinion of the intermediate second wheel 111, and a second detector wheel 113 that meshes with the pinion of the intermediate second wheel 111. The second hand 3B attaches to the second hand pivot 4B of the second wheel 112.

A indicator position detection hole that is detected by the indicator position detector 210 described below is formed in the intermediate second wheel 111 and the second detector wheel 113. Note that wheels with an indicator position detection hole are also disposed to the second wheel train 120, third wheel train 130, and indicator position detection wheel train 180, and indicator position detectors 220, 230, 240 corresponding to these holes are also provided.

The indicator position detector 210 includes a fifth wheel 121 that meshes with the rotor pinion of the second motor 102, a third wheel 122 that meshes with the pinion of the fifth wheel 121, and a second wheel 123 that meshes with the pinion of the third wheel 122. The second wheel 123 is superimposed in plan view with the second wheel 112. The minute hand 3C attaches to the minute hand pivot 4C of the second wheel 123.

The third wheel train 130 includes a first hour intermediate wheel 131 that meshes with the rotor pinion of the third motor 103; a second hour intermediate wheel 132 that meshes with the first hour intermediate wheel 131; a third hour intermediate wheel 133 that meshes with the second hour intermediate wheel 132; a fourth hour intermediate wheel 134 that meshes with the pinion of the third hour intermediate wheel 133; a fifth hour intermediate wheel 135 that meshes with the pinion of the fourth hour intermediate wheel 134; and an hour wheel and pinion 136 that meshes with the pinion of the fifth hour intermediate wheel 135. The hour wheel and pinion 136 is superimposed in plan view with the second wheel 112 and second wheel 123. The hour hand 3D attaches to the hour hand pivot 4D of the hour wheel and pinion 136.

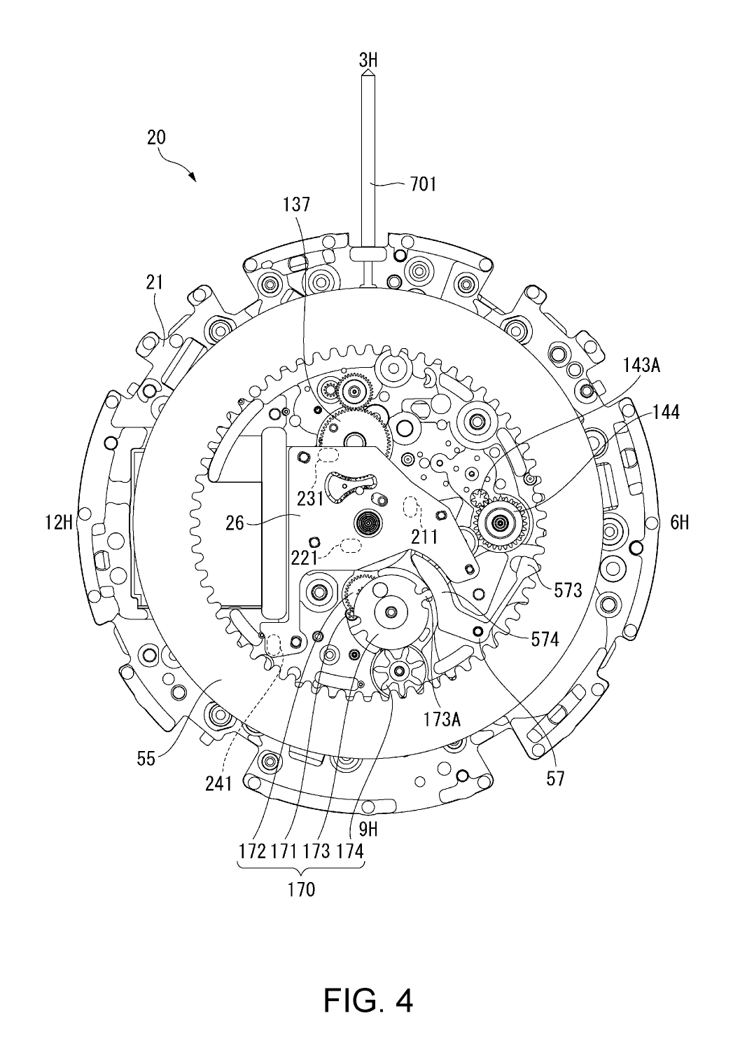

As shown in FIG. 4, a hour detection wheel 137 disposed on the back side of the main plate 21 meshes with the pinion of the fifth hour intermediate wheel 135.

The fourth wheel train 140 is the wheel train for driving the hands 791, 792 for indicating the home time (HT), and includes a home-time intermediate wheel 141 that meshes with the rotor pinion of the fourth motor 104; a home-time minute wheel 142 that meshes with the pinion of the home-time intermediate wheel 141; a home-time minute wheel and pinion 143; and a home-time hour wheel and pinion 144 that meshes with the pinion 143A of the home-time minute wheel and pinion 143 as shown in FIG. 4. In plan view, the home-time hour wheel and pinion 144 is superimposed with the home-time minute wheel 142, and is disposed on the back side of the main plate 21.

The small hand 791, which is the minute hand for home time, attaches to the home-time minute wheel 142, and the small hand 792, which is the hour hand for home time, attaches to the home-time hour wheel and pinion 144.

More specifically, the fourth motor 104 drives the hands 791, 792 that attach to the pivot 5D located toward 6:00 relative to the center arbor 4 (plane center O).

The fifth wheel train 150 is the wheel train that drives the small hand 771, which is disposed at the 3:00 position and is the day hand indicating the day of the week. As shown in FIG. 3, the fifth wheel train 150 includes a small day first intermediate wheel 151 that meshes with the rotor pinion of the fifth motor 105; a small day second intermediate wheel 152 that meshes with the pinion of the small day first intermediate wheel 151; and a small day wheel 153 that meshes with the pinion of the small day second intermediate wheel 152. The small day wheel 153 is disposed on the back side of the main plate 21, and the small hand 771 attaches to pivot 5B of the small day wheel 153.

In this electronic timepiece 1, the small day wheel 153 is superimposed in plan view with the 3:00 imaginary line L3. More specifically, the small day wheel 153 is disposed to a position where the angle of intersection between the 3:00 imaginary line L3 and a line through the pivot position of the pivot 5B of the small day second intermediate wheel 152 and the center arbor 4 (plane center O) is approximately 4 to 8 degrees, for example, 6 degrees.

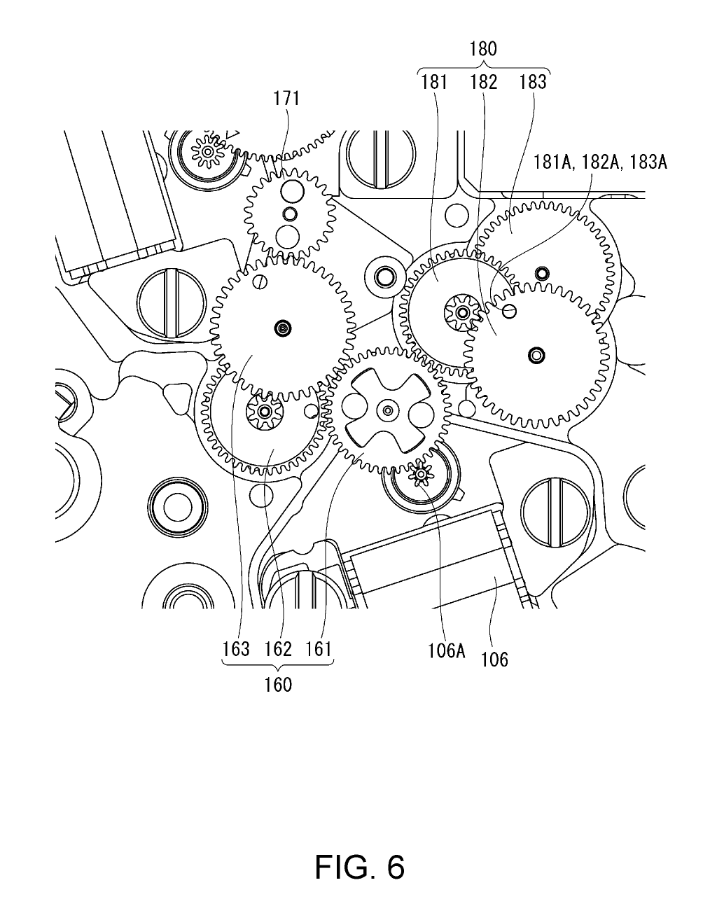

The sixth wheel train 160 is a wheel train for driving the small hand 781, which is a mode indicator (function indicator MI) and is disposed at a 9:00 position. As shown in FIG. 6, the sixth wheel train 160 includes a mode indicator first intermediate wheel 161 that meshes with the rotor pinion 106A of the sixth motor 106; a mode indicator second intermediate wheel 162 that meshes with the mode indicator first intermediate wheel 161; and a mode indicator wheel 163 that meshes with the pinion of the mode indicator second intermediate wheel 162. The small hand 781 attaches to the pivot 5C of the mode indicator wheel 163.

In this electronic timepiece 1, the mode indicator second intermediate wheel 162 and mode indicator wheel 163 are disposed to positions superimposed in plan view with the 9:00 imaginary line L9. More specifically, the mode indicator second intermediate wheel 162 and mode indicator wheel 163 are disposed to positions where the angle of intersection between the 9:00 imaginary line L9 and a line through the pivot position of the pivot 5C of the mode indicator wheel 163 and the center arbor 4 (plane center O) is approximately 4 to 8 degrees, for example, 6 degrees.

Date Indicator Wheel Train

The date indicator wheel train 170, which drives the date indicator 55 in conjunction with the small hand 781, and more specifically in conjunction with the sixth wheel train 160 that drives the small hand 781, is described next with reference to FIG. 3 to FIG. 7.

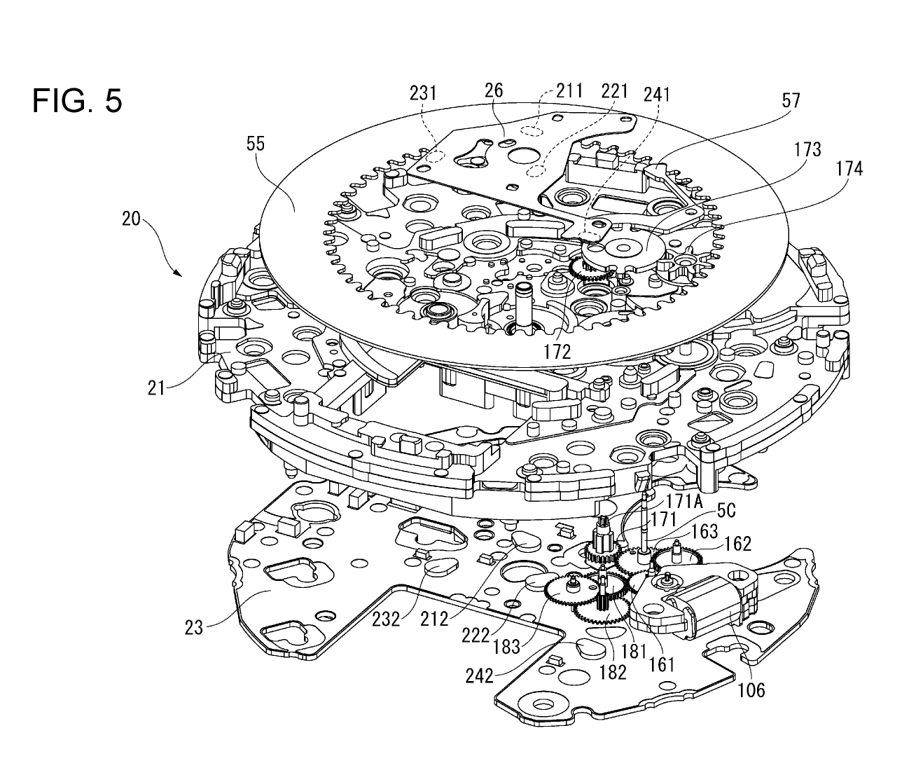

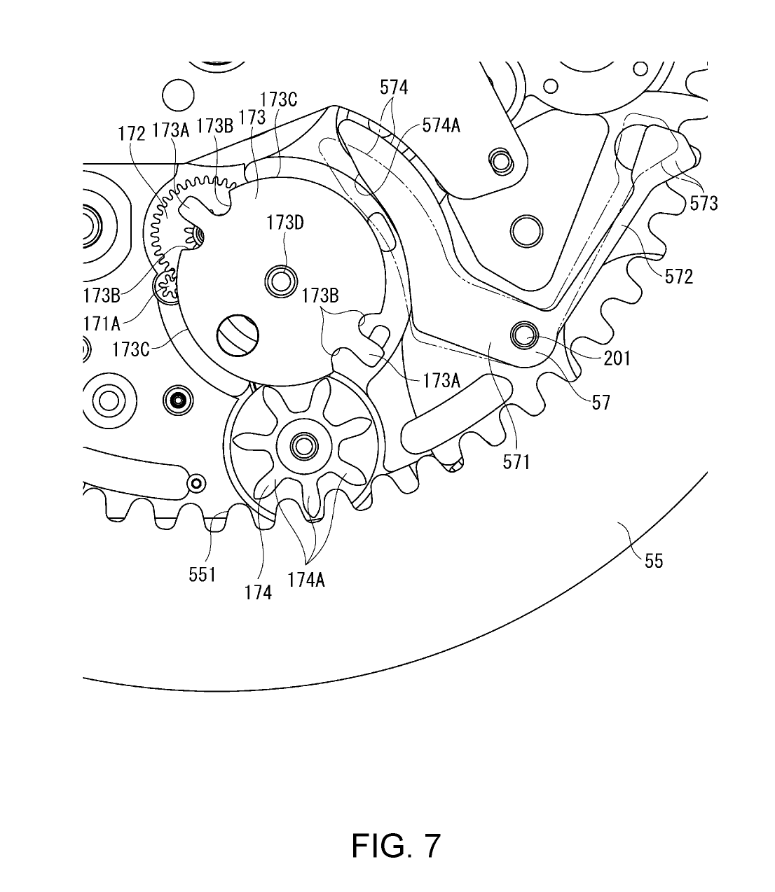

FIG. 3 is a plan view of main parts of the movement 20 described above from the back cover side. FIG. 4 is a plan view of the movement 20 from the dial side. Note that FIG. 4 shows when the small hand 781 is pointing to the F position, which is the reference position. FIG. 5 is an exploded oblique view of main parts of the movement 20. FIG. 6 is a plan view of the sixth wheel train 160 that drives a hand (mode indicator) 781 of the electronic timepiece 1, and the indicator position detection wheel train 180. FIG. 7 is a plan view of the date indicator wheel train 170 of the electronic timepiece 1 and the date jumper 57.

As shown in FIG. 3 to FIG. 7, the date indicator wheel train 170 includes a first intermediate date wheel 171, second intermediate date wheel 172, third intermediate date wheel 173, and date indicator driving wheel 174. The first intermediate date wheel 171 meshes with the mode indicator wheel 163, and its pivot passes through the main plate 21. The pinion 171A disposed to the pivot of the first intermediate date wheel 171 is exposed on the dial side of the main plate 21.

The second intermediate date wheel 172 and third intermediate date wheel 173 are disposed between the main plate 21 and the dial 50. The second intermediate date wheel 172 meshes with the pinion 171A of the first intermediate date wheel 171, and the third intermediate date wheel 173 meshes with the pinion of the second intermediate date wheel 172.

As shown in FIG. 7, the third intermediate date wheel 173 has a pair of drive teeth 173A formed on opposite sides of the pivot 173D. A pair of recesses 173B is formed at the base of each drive tooth 173A. The outside circumference surface of the third intermediate date wheel 173 between the recesses 173B is a curved restriction surface 173C.

The date indicator driving wheel 174 has multiple teeth 174A formed equidistantly around the circumference. The date indicator driving wheel 174 in this embodiment has seven teeth 174A. The teeth 174A mesh with the drive teeth 173A. The teeth 174A also mesh with the internal teeth 551 of the date indicator 55. Therefore, each time the third intermediate date wheel 173 turns 180°, it turns the date indicator driving wheel 174 two teeth (360°× 2/7), and turns the date indicator 55. When the drive teeth 173A are not meshed with the teeth 174A of the date indicator driving wheel 174, two teeth 174A of the date indicator driving wheel 174 are touching the restriction surface 173C of the third intermediate date wheel 173, and rotation of the date indicator driving wheel 174, and therefore the date indicator 55, is restricted. The third intermediate date wheel 173 and date indicator driving wheel 174 thus forma Geneva drive in the date indicator wheel train 170.

Indicator Position Detection Wheel Train

The indicator position detection wheel train 180, which turns in conjunction with the sixth wheel train 160, is described next.

As shown in FIG. 3, FIG. 5, and FIG. 6, the indicator position detection wheel train 180 has three wheels, a first detection wheel 181 that meshes with the mode indicator first intermediate wheel 161, a second detection wheel 182 that meshes with the pinion of the first detection wheel 181, and a third detection wheel 183 that meshes with the pinion of the second detection wheel 182.

When the mode indicator first intermediate wheel 161 is turned by the sixth motor 106, the first detection wheel 181, second detection wheel 182, and third detection wheel 183 turn sequentially in a speed reduction train. A through-hole 181A, 182A, 183A is respectively formed in each of the detection wheels 181, 182, 183, and the through-holes 181A, 182A, 183A are formed so that they are superimposed with each other in plan view at one location in one revolution of the third detection wheel 183.

Date Jumper

The date indicator 55 is regulated by a date jumper 57. As shown in FIG. 7, the date jumper 57 has a base portion 571 attached freely rotationally on a pivot 201 disposed to the main plate 21; an arm 572 extending from the base portion 571; a pawl 573 that engages the internal teeth 551 and is disposed on the distal end of the arm 572; and a guide 574 extending from the base portion 571 along the outside surface of the third intermediate date wheel 173.

The arm 572 has spring, and is configured to flex when the pawl 573 engages the internal teeth 551, and push the pawl 573 against the base portion 571 by the spring force corresponding to the flexure.

The guide 574 has a curved face 574A opposite the third intermediate date wheel 173. As shown in FIG. 4, the teeth 174A is configured to guide the drive teeth 173A of the third intermediate date wheel 173.

In the mode display range of the small hand 781 (indicator display range), the drive teeth 173A of the third intermediate date wheel 173 move in the range of continuous contact with the curved face 574A. As a result, because the position of the guide 574 is restricted by the drive teeth 173A, the date jumper 57 is held with the pawl 573 engaged with the internal teeth 551.

However, as shown in FIG. 7, when the drive teeth 173A are outside the range of contact with the curved face 574A (date jumper enabled range), the guide 574 is separated from the restriction surface 173C of the third intermediate date wheel 173. As a result, the date jumper 57 can rotate in the direction in which the guide 574 approaches the restriction surface 173C as indicated by the dot-dash line in FIG. 7. As a result, the pawl 573 of the date jumper 57 releases the internal teeth 551. Therefore, when the date indicator driving wheel 174 turns the date indicator 55, restriction of the date indicator 55 by the date jumper 57 is released, and the torque required to turn the date indicator 55 can be reduced.

Indicator Position Detectors

As described above, the electronic timepiece 1 has four indicator position detectors 210, 220, 230, 240. As shown in FIG. 4 and FIG. 5, the indicator position detector 210 has a light-emitting device 211 disposed to the light sensor circuit board 26, and a photodetector 212 disposed to the circuit board 23. Similarly, the indicator position detector 220 has a light-emitting device 221 disposed to the light sensor circuit board 26, and a photodetector 222 disposed to the circuit board 23. The indicator position detector 230 has a light-emitting device 231 disposed to the light sensor circuit board 26, and a photodetector 232 disposed to the circuit board 23. The indicator position detector 240 has a light-emitting device 241 disposed to the light sensor circuit board 26, and a photodetector 242 disposed to the circuit board 23.

Setting Mechanism

The setting mechanism 700 is a device that operates in conjunction with operation of the crown 6, and is a typical setting mechanism having, in addition to the winding stem 701 to which the crown 6 is attached, a setting lever, yoke, click spring, switch lever, setting lever holder, switch contact spring main, switch contact spring, and switch wheel as shown in FIG. 3.

As shown in FIG. 3 and FIG. 4, the winding stem 701 is disposed in the movement 20 at the 3:00 position on the dial 50 as seen in plan view.

The setting mechanism 700 having a setting lever and other parts in addition the winding stem 701 is disposed across the 3:00 imaginary line L3 and 4:00 imaginary line L4 along the outside circumference of the dial 50.

While not shown in the figures, a circuit cover, magnetic shield, antenna holder, wheel train bridge, and other components are also disposed on the front side of the main plate 21 in addition to the configurations described above.

While also not shown in the figures, hour wheel bridge, magnetic shield, date indicator bridge, and other components are also disposed on the back side of the main plate 21 in addition to the configurations described above.

The configurations of these elements are known from the literature, and further description thereof is omitted.

Controller

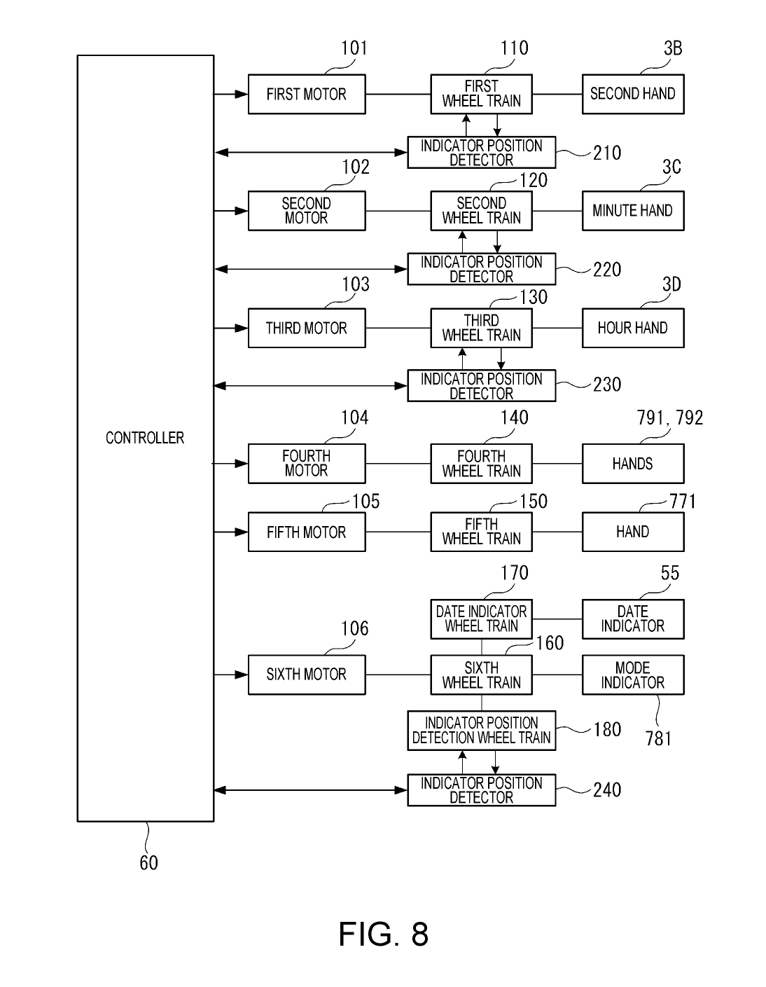

The controller 60 of the electronic timepiece 1 is described next. FIG. 8 is a block diagram showing the relationship between the controller of the electronic timepiece and the motors, wheel trains, and indicator position detectors.

The controller 60 in this example is embodied by an IC chip on the circuit board 23, and controls operations of the electronic timepiece 1. As shown in FIG. 8, the controller 60 controls driving the first motor 101 to the sixth motor 106. The controller 60 also controls driving the indicator position detectors 210, 220, 230, 240 and executing the indicator position detection process.

Indicator Position Detector for the Function Indicator

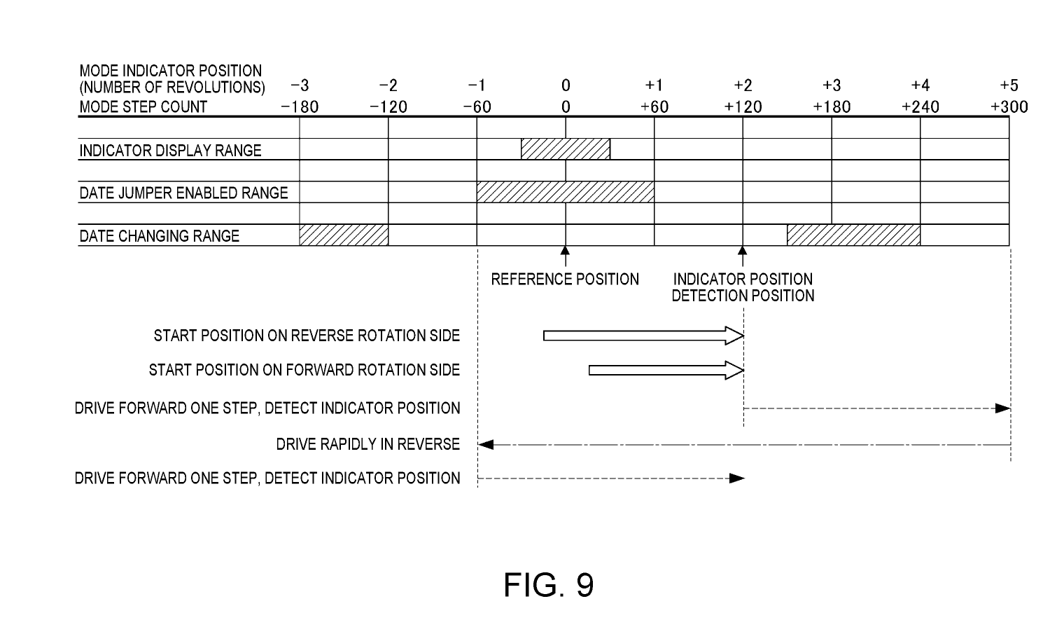

The indicator position detector 240 that detects the indicator position of the small hand 781, which is the mode indicator, is described below with reference to FIG. 6, FIG. 7, and FIG. 9. FIG. 9 shows the relationship between the mode indicator position, step count of the motor, indicator display range, date jumper enabled range, and date indicator driving range.

As shown in FIG. 6, the indicator position detector 240 detects the position of the indicator position detection wheel train 180, or more specifically the position of the small hand 781 driven by the sixth wheel train 160, by the photodetector 242 disposed to the circuit board 23 detecting the light emitted from the light-emitting device 241 disposed to the light sensor circuit board 26 passing through the through-holes 181A, 182A, 183A in the indicator position detection wheel train 180, which turns in conjunction with the sixth wheel train 160 that drives the small hand 781.

In this embodiment of the invention, the position of the third intermediate date wheel 173 shown in FIG. 7, or more specifically the position of the drive teeth 173A positioned between the guide 574 and the date indicator driving wheel 174, is the indicator position detection position. More specifically, as described below, the indicator position detection position is set to 120 steps past the number of motor steps from the reference position at 0 steps.

In this embodiment of the invention the sixth motor 106 and sixth wheel train 160 are configured so that when the sixth motor 106 moves one step, the small hand 781 turns 6°. As a result, when the sixth motor 106 drives 60 steps, the 781 turns 360° (one revolution).

The indicator position detection wheel train 180 is configured so that when the sixth motor 106 drives 360 steps, the third detection wheel 183 turns one revolution (moves 360°). Therefore, the through-holes 181A, 182A, 183A of the detection wheels 181, 182, 183 are superimposed with each other during one step when the sixth motor 106 drives 360 steps. Note that when the sixth motor 106 drives 360 steps, the small hand 781 turns six revolutions.

When the sixth motor 106 drives 360 steps, the third intermediate date wheel 173 turns 180°. At this time the drive teeth 173A of the third intermediate date wheel 173 cause the date indicator driving wheel 174 to turn two teeth (360°× 2/7). The date indicator 55 has 62 internal teeth, and when the date indicator driving wheel 174 turns two teeth, the date indicator 55 also turns two teeth, that is, moves one day.

The reference position of the small hand 781 in this embodiment is the position where the small hand 781 points to the F marker of the power indicator, that is, is positioned pointing to 9:00 in the second subdial 780 as shown in FIG. 1.

When the sixth motor 106 drives forward, the small hand 781 turns in reverse (counterclockwise in this example) and the date indicator 55 turns forward (clockwise). Note that when the small hand 781 turns in reverse, it moves from the F marker of the power indicator to E, and in the direction to the A, S, and D markers (counterclockwise). When the date indicator 55 turns forward, it turns in the direction advancing the date (clockwise).

When the sixth motor 106 drives in the reverse direction, the small hand 781 turns forward, and the date indicator 55 turns in reverse. In this case, the small hand 781 moves from the F marker of the power indicator to the airplane icon (airplane mode indicator), and moves in the direction toward the 1, 4+, and L markers (clockwise). When the date indicator 55 turns in reverse, it moves in the direction reversing the date (counterclockwise).

In this embodiment, as shown in FIG. 9, expressed as the number of motor steps where the reference position is 0, the indicator display range in which the small hand 781 indicates mode information is the range from approximately −30 to +30 steps, that is, the range in which the small hand 781 turns approximately one revolution (360°) from −180° to +180°. In this event, the angle the third intermediate date wheel 173 turns is approximately 30°, and as shown in FIG. 4, the drive teeth 173A move in the range in contact with and guided by the curved face 574A.

As a result, the date jumper 57 is held in the position indicated by the solid line in FIG. 7 by the guide 574 contacting the drive teeth 173A, the pawl 573 engages an internal tooth 551, and the date jumper 57 is enabled.

In the range in which the date jumper 57 function is enabled (date jumper enabled range), expressed by the number of motor steps, is approximately −60 to +60 steps, and the angle the third intermediate date wheel 173 turns is approximately 60°. More specifically, the date jumper enabled range is set so that a drive tooth 173A contacts the curved face 574A when the third intermediate date wheel 173 turns in a range of approximately 60°.

The date driving range in which the drive teeth 173A turns the date indicator driving wheel 174 and drives the date indicator 55, expressed by the number of motor steps, is a range of approximately +150 steps to +240 steps. Note that because the state of the small hand 781 and wheel train is the same at +180 steps and −180 steps, if expressed as a continuous range from +180 to −180, the date driving range is from +180 steps to −120 steps.

The indicator position detection position is outside the enabled range of the date jumper 57, and outside the date driving range, and, expressed by the number of motor steps, is set to the position at +120 steps in this example.

Note that FIG. 9 illustrates only one example, and may be changed as desired according to the design.

Indicator Position Detection Process of the Function Indicator

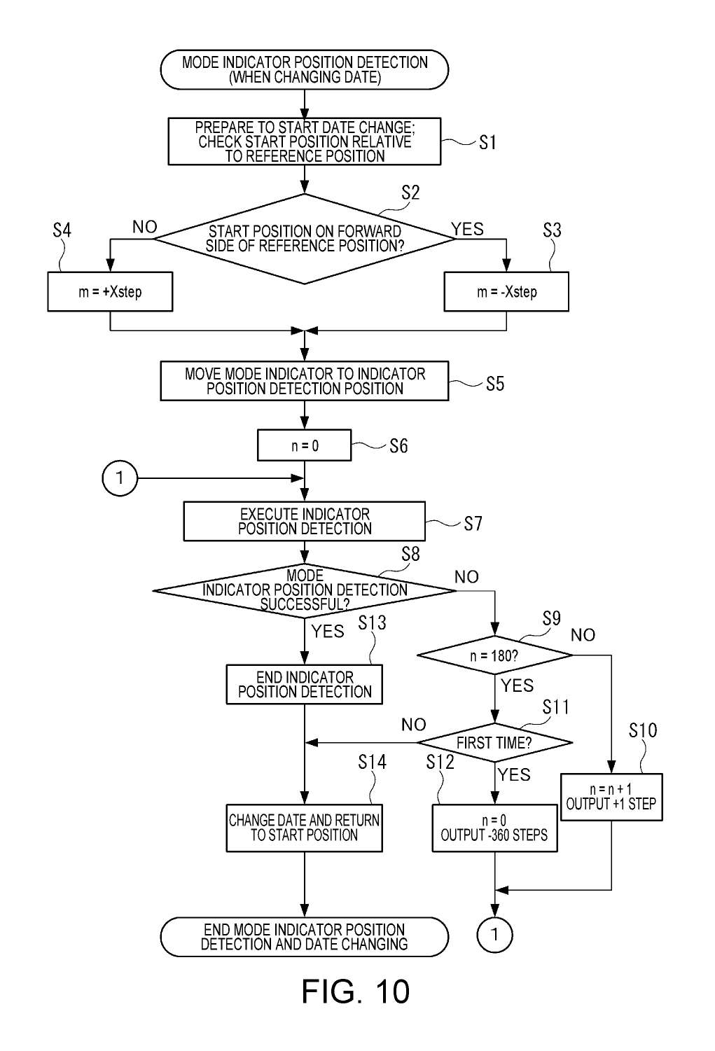

The regularly executed indicator position detection process, and more specifically the process of detecting the indicator position when changing the date, is described below with reference to FIG. 10.

In preparation for starting the date driving operation to drive the date indicator 55 to change the date, the controller 60 first checks the position currently indicated by the small hand 781 (start position), and confirms the start position relative to the reference position (F marker) (S1).

The controller 60 then determines if the start position relative to the reference position is on the forward rotation side of the sixth motor 106 (S2).

If the small hand 781 is pointing to a position in the power indicator range, or is pointing to the A, S, or D marker in the daylight saving time range, the controller 60 determines the start position is on the forward rotation side of the sixth motor 106 relative to the reference position. If the small hand 781 is indicating an airplane mode, time keeping mode, navigation mode, or leap second reception mode, the controller 60 determines the start position relative to the reference position is in the reverse rotation direction of the sixth motor 106.

If S2 returns YES, the controller 60 sets the specified pulse count m, which is the number of steps required to move the small hand 781 to the reference position, as the step count X corresponding to the start position (S3).

Note that if the start position is on the forward rotation side, the rotor of the sixth motor 106 must turn in reverse to return to the reference position, and the number of steps in the reverse direction is expressed by a negative value. For example, if the small hand 781 is pointing to a middle position in the power indicator (such as 8:00), and the number of steps to return to the reference position (9:00 position) is 5, (m=−5) is returned on S3.

If S2 returns NO, the specified pulse count m to move the small hand 781 to the reference position is the step count X to the start position (S4). If the start position is in the reverse direction, the rotor turns forward. For example, if the small hand 781 is pointing to the airplane mode position (10:00), and the number of steps to return to the reference position (9:00) is 5, S4 returns (m=5).

If the start position is the reference position, the direction of rotation may be either forward or reverse, and both step S3 and S4 return m=0.

Next, the controller 60 controls driving the sixth motor 106 to move the small hand 781 to the indicator position detection position (S5). More specifically, the movement control distance, which is the number of steps I required to move from the reference position to the indicator position detection position, is previously set. In this embodiment, the indicator position detection position is on the forward rotation side of the reference position, and more specifically is set to +120 steps.

Note that in this example the controller 60 stores the movement control distance as the number of steps (−120 steps) required to move from the indicator position detection position to the reference position. As a result, the movement control distance from the reference position to the indicator position detection position may be used by changing the sign (+ or −) of the stored number of steps.

Because the number of steps required to move from the start position to the reference position is the specified pulse count m described above, the number of steps A needed to move from the start position to the indicator position detection position is I+m. For example, if the start position is on the forward direction side of the reference position, and m=−5, the number of steps A=+120+(−5)=+115. However, if the start position is on the reverse direction side of the reference position, and m=5, the number of steps A=+120+(5)=+125. As shown in FIG. 9, when the start position is on the reverse direction side, the number of steps required to move to the indicator position detection position is greater than when the start position is on the forward direction side.

The controller 60 also initializes the variable n, which indicates the indicator position detection count, to 0 (S6).

Next, the controller 60 controls the indicator position detector 240 to detect the indicator position (S7). More specifically, the controller 60 executes the indicator position detection process of controlling the light-emitting device 241 to emit, and check whether or not light was detected by the photodetector 242. Based on the result, the controller 60 determines whether or not the position of the mode indicator was detected (S8).

If S8 returns YES, the controller 60 runs the process from S13 as described below.

Note that if the position of the small hand 781 has not shifted, the small hand 781 moves to the indicator position detection position in S5. As a result, the through-holes 181A, 182A, 183A in the detection wheels 181 to detection wheel 183 are aligned with each other between the light-emitting device 241 and photodetector 242, and the first indicator position detection is successful.

However, if S8 returns NO, the controller 60 determines if indicator position detection count n=180 (S9). If indicator position detection count n does not equal 180 (S9 returns NO), the controller 60 adds 1 to n, and outputs a signal driving the sixth motor 106 one step forward (S10). As a result, the small hand 781 moves one step in the reverse direction.

Control then returns to S7, and the controller 60 sequentially repeats the indicator position detection process (S7), and the success determination process (S8).

If the controller 60 continues to return NO in S8 until the indicator position detection count n reaches 180 (S9 returns YES), the controller 60 determines if it is the first time S9 returns YES (S11). If the controller 60 determines in S11 that it is the first time, the controller 60 resets n=0, and outputs −360 steps (S12). As a result, the sixth motor 106 is driven 360 steps in reverse, and the small hand 781 turns six revolutions clockwise. Because the indicator position is not detected when driving in reverse, the controller 60 drives the sixth motor 106 rapidly in reverse.

Control then returns to S7, and the controller 60 sequentially repeats the indicator position detection process (S7), and the success determination process (S8).

Referring to FIG. 9, suppose, for example, that the small hand 781 shifted position due to an external disturbance, and the actual indicator position detection position is at the motor step count +118 steps. In this case, indicator position detection will not be successful from the position at motor step counts +120 to +300 even if the indicator position detection process executes 180 times. As a result, the controller 60 rapidly drives the sixth motor 106 360 steps in reverse from +300 to the −60 position. The controller 60 then executes the indicator position detection process while driving the sixth motor 106 one step at a time from −60 to the +120 position. If indicator position detection is then successful when the motor step count reaches the +118 position, that position is correctly the motor step count +120 position, and the position moved −120 steps from that position can be detected as the reference position.

Note that the indicator position detection process is executed by moving forward one step at a time after driving the sixth motor 106 −360 steps in order to eliminate the effects of backlash between the wheels in the sixth wheel train 160 and indicator position detection wheel train 180. More specifically, when the sixth motor 106 is driven rapidly in reverse, backlash between the wheels can cause alignment of the through-holes 181A, 182A, 183A to shift. As a result, because the indicator position detection process always executes with the light-emitting device 241 and photodetector 242 while driving the sixth motor 106 forward, the indicator position detection process is executed +1 step at a time after driving −360 steps.

The controller 60 repeats the process of steps S7 and S8 until n=180, and executes the indicator position detection process until the sixth motor 106 is driven forward 180 steps. When indicator position detection is successful (S8 returns YES), the controller 60 ends the indicator position detection process (S13).

Next, the controller 60 drives the date and returns the small hand 781 to the start position (S14).

Because the small hand 781 is at the indicator position detection position at +120 steps from the reference position when indicator position detection is successful, the date can be advanced by moving the sixth motor 106 forward 120 steps to the position at +240 steps (the same as the position at −120 steps in FIG. 9). In addition, to return to the start position, the sixth motor 106 can be moved the required number of steps forward.

For example, if the start position is the reference position, to change the date one day from the indicator position detection position (the +120 step position) and return to the reference position, the sixth motor 106 can be moved forward +240 steps.

In addition, if the start position is different from the reference position, and is a position where the reference position can be reached by moving m steps, the start position can be reached by moving −m steps from the reference position.

As a result, to advance the date one day from the indicator position detection position and return to the start position, the sixth motor 106 can be moved forward (+240−m) steps. For example, if the start position is on the reverse direction side of the sixth motor 106 relative to the reference position, and m=5, in S14 the controller 60 moves the sixth motor 106 +240−5=+235 steps. However, if the start position is on the forward direction side of the sixth motor 106 relative to the reference position, and m=−5, in S14 the controller 60 moves the sixth motor 106 +240−(−5)=+245 steps.

Note that if the date is advanced 2 or more days to reach the first of the next month from a short month, the sixth motor 106 can be simply driven an additional +360 steps per day.

This completes the mode indicator position detection and date driving process when changing the date.

Because the indicator position detection wheel train 180 is driven one revolution to detect the indicator position when the controller 60 returns NO in S11, that is, if S9 returns YES a second time, indicator position detection may be determined to not succeed because of a malfunction of the indicator position detector 240 or other reason. Therefore, if S11 returns NO, the controller 60 determines that indicator position detection failed. However, even if indicator position detection failed, the position at which the controller 60 determines NO in S11 is the position moved +180 steps, −360 steps, and +180 steps from the position moved to in S5, and is therefore the original position (the position moved to in S5, that is, the position supposed to be the indicator position detection position). Therefore, because the position relative to the start position is the same as when indicator position detection is determined successful, by moving the sixth motor 106 (+240−m) steps, the date can be changed one day and the hand returned to the start position.

However, if S14 executes, the user cannot know that indicator position detection failed, and may therefore mistakenly believe the information indicated by the small hand 781 is correct. Therefore, if S11 returns NO, the small hand 781 may be moved to a position indicating that indicator position detection failed, such as a position between the E marker in the power indicator and the A marker in the daylight saving time indicator.

This completes the date driving process and mode indicator position detection process.

Scheduled Indicator Position Detection of the Second Hand, Minute Hand, and Hour Hand

Detecting the locations of the second hand 3B, minute hand 3C, and hour hand 3D is timed to when the hands are normally at the 12:00 position, the indicator position detection position, at 00:00:00 and 12:00:00. Note that the indicator position detection process of the second hand 3B, minute hand 3C, and hour hand 3D is not limited to twice daily, and may execute one a day (at 00:00:00 or 12:00:00).

The second hand 3B, minute hand 3C, hour hand 3D position detection process may execute as known from the literature. For example, the controller 60 may first control the indicator position detector 210 to detect the indicator position of the secondhand 3B, then control indicator position detector 220 to detect the indicator position of the minute hand 3C, and finally control indicator position detector 230 to detect the indicator position of the hour hand 3D.

When the controller 60 detects the position of the small hand 781, that is, the mode indicator, in addition to the second hand 3B, minute hand 3C, and hour hand 3D, the controller 60 preferably detects the positions of the second hand 3B, minute hand 3C, and hour hand 3D, and then detects the position of the small hand 781. By sequentially detecting the position of each hand, a temporary increase in consumption current can be suppressed.

Indicator Position Detection During a System Reset

Because the value of the indicator position counter storing the position of each hand is also reset during a system reset, and the controller 60 cannot detect the current positions of the hands, the controller 60 sequentially executes the indicator position detection processes for the secondhand 3B, minute hand 3C, hour hand 3D, and small hand 781 during a system reset.

The indicator position detection processes of the second hand 3B, minute hand 3C, and hour hand 3D execute as usual by moving the motors 101 to 103 that move the hands one step and a time and controlling the indicator position detectors 210 to 230.

Because the current start position of the small hand 781 is unknown, and the indicator position detection process cannot be started after moving to the indicator position detection position, the indicator position detection process of the small hand 781 starts the indicator position detection process from the current position.

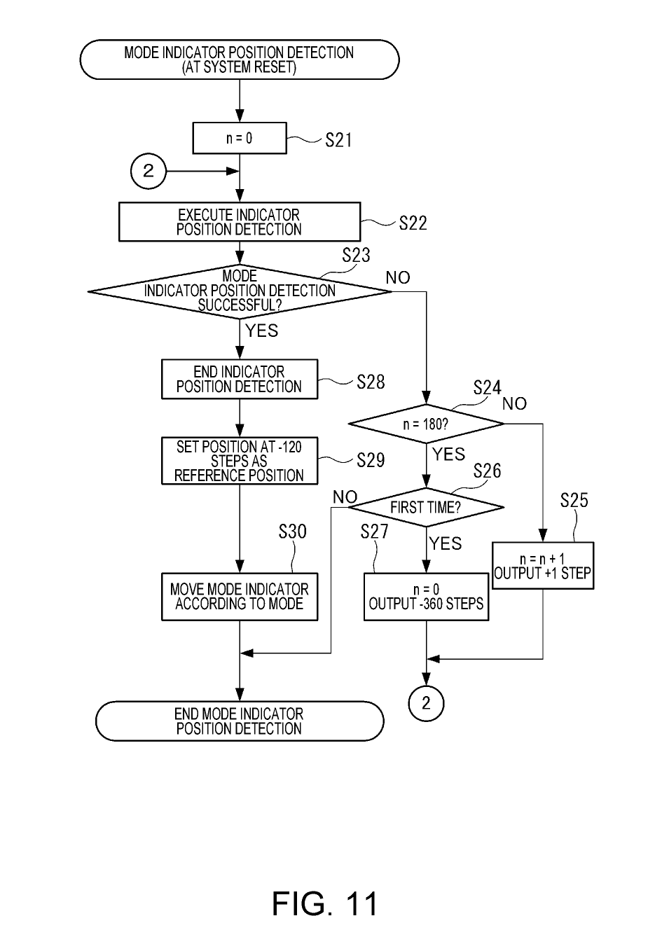

As a result, the controller 60 executes the process shown in the flow chart in FIG. 11. Note that steps S21 to S28 in the flow chart in FIG. 11 are the same as step S6 to S13 in the flow chart in FIG. 10, and further description thereof is omitted.

The controller 60 initializes the indicator position detection count n to 0 when starting the process in FIG. 11 (S21), then controls the indicator position detector 240 to run the indicator position detection process (S22), and determines if detecting the mode indicator position was successful (S23). If S23 returns NO, the controller 60 determines if n=180 (S24), and if S24 returns NO, adds 1 to n and drives the sixth motor 106 one step (S25), then returns to S22 and repeats indicator position detection.

The controller 60 then repeats the process from S22 to S25, and if S23 returns NO, n=180, and S24 returns YES, the controller 60 determines if this is the first time n=180 (S26). If it is the first time (S26 returns YES), the controller 60 resets n=0, drives the sixth motor 106 −360 steps in reverse (S27), and repeats steps S22 to S25 again.

If S23 returns YES, the controller 60 ends indicator position detection (S28), and sets the position −120 steps from this indicator position as the reference position (S29).

The controller 60 then moves the small hand 781 from the reference position set in S29 to the position corresponding to the specified mode (S30).

Immediately after the system reset, the small hand 781 is set to the power indicator range, which is the standard display position. As a result, the controller 60 measures the voltage of the storage battery 24, and moves the small hand 781 to the position appropriate to the measured value. If another mode is set or selected to display information other than the power reserve, the small hand 781 moves to the corresponding position. This ends the mode position detection process during a system reset.

Note that if S26 returns NO, the controller 60 stops the small hand 781 at the current position, and ends the process.

Indicator Position Detection when Setting the Reference Position

The electronic timepiece 1 also has a function for executing the indicator position detection process when, for example, the user notices a shift in the position indicated by the small hand 781 and operates the crown and button 7A to assert a command for resetting the small hand 781 to the reference position. The indicator position detection process in this case is the same as the process executed in a system reset as shown in FIG. 11, and further description thereof is omitted.

### Effect of the Invention

Because the electronic timepiece 1 can drive the mode indicator hand 781 and the date indicator 55 by the same sixth motor 106, space is saved and a compact multifunction timepiece can be provided.

The position of the small hand 781 can also be detected by the indicator position detector 240 even when the position of the small hand 781 shifts due to an external disturbance. The small hand 781 can therefore be returned to the reference position based on the detected indicator position, and correct information can be indicated by the small hand 781. In addition, because the relative positions of the small hand 781 and date indicator 55 can be correctly determined, the controller 60 can correctly move the date indicator 55.

Because the position of the small hand 781 is detected when changing the date by the sixth motor 106 moving the date indicator 55, a drop in user convenience can be prevented, and power consumption per day can be reduced. More specifically, when detecting the position of the small hand 781, the small hand 781 turns a maximum six revolutions, and if the small hand 781 position is detected during the day when the user is most likely using the electronic timepiece 1, the user will be unable to get desired information from the small hand 781, and user convenience decreases. However, if the small hand 781 position is detected when the date changes, a drop in user convenience can be prevented because the likelihood that the user is not using the electronic timepiece 1 is high.

Furthermore, because the small hand 781 also turns six revolutions when the date is driven, if indicator position detection is executed when the date changes, the operation of driving the small hand 781 six revolutions can be limited to once a day, and the power consumption per day can be reduced.

Furthermore, because the controller 60 executes the indicator position detection process on a regular schedule, the position of the small hand 781 can be automatically corrected. As a result, the small hand 781 can always be moved to the normal position and held in the correct relationship with the date indicator 55 even when the user is not aware that the position of the small hand 781 has shifted. The small hand 781 can therefore always indicate the correct information.

If the position of the small hand 781 has not shifted, the controller 60 can detect the indicator position when the indicator position detection count n=0, that is, the first time in the indicator position detection process when changing the date, because the indicator position is detected in step S7 after the small hand 781 moves to the indicator position detection position in step S5. Therefore, the probability that the regularly executed indicator position detection process can be completed in a short time is improved, and power consumption by the indicator position detection process can be reduced.

When the reference position of the small hand 781 is at a motor step count of 0, the indicator position detection position is set to a position other than +120 steps, and the controller 60 stores −120 steps as the movement control distance from the indicator position detection position to the reference position.

Therefore, the location of the reference position relative to the indicator position detection position can be set freely by simply changing the value of the movement control distance setting. As a result, if the location of the second subdial 780 is changed and the reference position is set at 12:00, this variation can be easily accommodated by simply changing the movement control distance. The reference position of the small hand 781 can therefore be set according to the timepiece design and displayed information, and an electronic timepiece 1 with excellent user convenience can be provided.

Furthermore, because the indicator position detection position can be set freely with no relationship to the reference position, the indicator position detector 240 can be conveniently located and the third intermediate date wheel 173 can be located at an easily installable position. If as shown in FIG. 7 the indicator position detection position is outside the date jumper 57 enable range and outside the date driving range, the drive teeth 173A can be disposed to a position that does not interfere with the date jumper 57 and the date indicator driving wheel 174 when installing the third intermediate date wheel 173, and the third intermediate date wheel 173 can be easily installed.

In addition, because the indicator position can be detected as soon as the third intermediate date wheel 173 is installed, that the sixth wheel train 160, date indicator wheel train 170, and indicator position detection wheel train 180 are set to the indicator position detection position can be easily confirmed immediately after installation. Therefore, the time until the small hand 781 is installed to the pivot 5C after confirming the sixth wheel train 160 is at the indicator position detection position can be shortened, and timepiece assembly is more efficient.

Because a dedicated indicator position detection wheel train 180 that moves in conjunction with the sixth wheel train 160 is provided to detect the indicator position with the indicator position detector 240, the location of the indicator position detector 240 can be determined more freely, and the layout of the parts in the movement 20 can be designed more freely. In addition, the number and the reduction ratio of detection wheels 181 to detection wheel third detection wheel 183 in the indicator position detection wheel train 180 can also set as needed. As a result, the maximum number of revolutions of the small hand 781 required to detect the indicator position is not limited to six as in this embodiment, and may be five or less or seven or more, enabling easily adapting to the configuration of the indicator position detection wheel train 180.

Because the drive teeth 173A contacts the curved face 574A when the small hand 781 is in the indicator display range, the pawl 573 of the date jumper 57 can be kept engaged with the internal teeth 551. Furthermore, because the drive teeth 173A separates from the range of contact with the curved face 574A when advancing the date, the restriction on date indicator 55 movement by the date jumper 57 can be removed, and the torque required to turn the date indicator 55 can be reduced. Therefore, the third intermediate date wheel 173 can also be used to switch between enabling the date jumper 57 and restricting the date jumper 57.

Furthermore, because the indicator position detection processes of the second hand 3B, minute hand 3C, and hour hand 3D, and small hand 781 execute automatically immediately after a system reset of the electronic timepiece 1, the hands can be moved to the normal positions, and a correct relationship to the date indicator 55 that moves in conjunction with the small hand 781 can be maintained.

In addition, because the controller 60 executes the same indicator position detection process executed as part of a system reset when the user performs an operation with the buttons 7A to 7D to set the reference position, the user can start the indicator position detection process when the user notices the position of the small hand 781 has shifted. As a result, the small hand 781 can be returned to the correct position, and the normal relationship to the date indicator 55 can be maintained.

### OTHER EMBODIMENTS

The invention is not limited to the embodiments described above, and can be modified and improved in many ways without departing from the scope of the accompanying claims.

For example, the reference position and the indicator position detection position are different positions in the foregoing embodiment, but may be the same position. For example, the reference position in the foregoing embodiment may be the indicator position detection position, or the indicator position detection position may be set within the indicator display range. In this case, because the number of steps the small hand 781 must move from the current display position to the indicator position detection position in the indicator position detection process is small, and the small hand 781 can move to the indicator position detection position in less than one full revolution, the indicator position detection process can be completed in less time when the shift in position due to an external disturbance, for example, is small.

The embodiment described above executes the scheduled indicator position detection process of the small hand 781 when advancing the date, but the indicator position detection process may be executed at a time other than when the date changes, such as 7:00 a.m. or 12:00 a.m.

In addition, the indicator position detection process of the small hand 781 may execute when the user operates a button 7A to 7D or the crown 6 to change the date, or when the date indicator 55 is adjusted by receiving time information. In this case, considering the effects of backlash, the indicator position detection process does not execute when the date indicator 55 turns in reverse, and the indicator position detection process executes only when the date indicator 55 is turning forward.

As shown in FIG. 10 and FIG. 11, when the small hand 781 is driven +180 steps and the indicator position cannot be detected in the embodiment described above, the small hand 781 is reversed rapidly −360 steps and is then driven +180 steps, but may be driven forward only +360 steps from step 0 to detect the indicator position. In this case, when changing the date, the date can be advanced one day at simultaneously to indicator position detection.

Furthermore, the indicator position is detected in step S7 after moving to the indicator position detection position in S5, but the small hand 781 may be moved to the reference position in S5 and the sixth motor 106 then driven one step at a time from this position to detect the indicator position. In this case, when the actual indicator position detection position is in the range from motor step count +0 to +119 in FIG. 9, indicator position detection can succeed in fewer steps than the embodiment described above.

The display member driven by the same sixth motor 106 that drives the small hand 781 is the date indicator 55 in the embodiment described above, but the display member may be any member for displaying time-based information. Examples of such display members including a subdial for displaying home time (local time), a 24-hour hand that displays time with one revolution per 24 hours, or a calendar wheel displaying information other than the date.

Calendar wheels displaying information other than the date include a day wheel displaying the weekday, a month wheel displaying the month, or a moon phase wheel. In other words, the display member may be any member for displaying information based on time, and is normally driven at a regular interval.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No. 2018-082327, filed Apr. 23, 2018 is expressly incorporated by reference herein.

What is claimed is:

1. An electronic timepiece comprising:
a function indicator configured to display information other than time;
a motor configured to drive the function indicator;
a calendar wheel driven by the motor in conjunction with the function indicator to display information based on time;
an indicator position detection mechanism configured to detect the function indicator at an indicator position detection position; and
a controller configured to execute a process of driving the calendar wheel when a date is changed once a day, and a process of controlling the motor and the indicator position detection mechanism to detect an indicator position of the function indicator when controlling driving the calendar wheel.

2. An electronic timepiece comprising:
a function indicator configured to display information other than time;
a driver configured to drive the function indicator;
an indicator position detection mechanism configured to detect the function indicator at an indicator position detection position; and
a controller configured to execute a process of controlling the driver and the indicator position detection mechanism to detect the function indicator.

3. The electronic timepiece described in claim 2, wherein:
the controller executes the indicator position detection process after a system reset.

4. The electronic timepiece described in claim 2, further comprising:
an operating member having a button or crown;
the controller executing the indicator position detection process when a command to set to a reference position is input based on operation of the operating member.

5. The electronic timepiece described in claim 2, wherein:
the controller regularly executes the indicator position detection process.

6. The electronic timepiece described in claim 2, further comprising:
a calendar wheel driven in conjunction with the function indicator by the same motor as a motor that drives the function indicator;
the controller executing the indicator position detection process when controlling driving the calendar wheel.

7. The electronic timepiece described in claim 6, wherein:
the calendar wheel is a date wheel; and
the controller executes the indicator position detection process when a date is changed once a day.

8. The electronic timepiece described in claim 2, wherein:
a reference position of the function indicator and the indicator position detection process are different positions; and
the controller stores a movement control distance the function indicator is moved from the indicator position detection position to the reference position.
